(19) United States
(12) Patent Application Publication
(10) Pub. No.: US 2013/0092352 A1
(43) Pub. Date: Apr. 18, 2013

(54) COOLER, STRUCTURE FOR TRANSPORTING AND METHOD OF TRANSPORTING THE SAME

(71) Applicants: Indian MARTIN, Tulsa, OK (US); John MILLER, Owasso, OK (US); Bradley WHITE, Claremore, OK (US); Shannon FAUST, Broken Arrow, OK (US); Alan GURKA, Owasso, OK (US); Chris BYFIELD, Inola, OK (US)

(72) Inventors: Indian MARTIN, Tulsa, OK (US); John MILLER, Owasso, OK (US); Bradley WHITE, Claremore, OK (US); Shannon FAUST, Broken Arrow, OK (US); Alan GURKA, Owasso, OK (US); Chris BYFIELD, Inola, OK (US)

(73) Assignee: HARSCO CORPORATION, Camp Hill, PA (US)

(21) Appl. No.: 13/273,278

(22) Filed: Oct. 14, 2011

(51) Int. Cl. F28F 9/00; B65G 65/00

(52) U.S. Cl. 165/68; 414/816

(57) ABSTRACT

A cooler, structure for transporting a cooler and a method for transporting the same are disclosed. The cooler has a cooling region defined by a support wall, a first wall, a second wall, and a sloped interior section, the sloped interior section extending between the first wall and the second wall and sloping away from the support wall. A discharge region is provided and is defined by the first wall, the second wall, the sloped interior section, and a vertical wall, the vertical wall being substantially parallel to the support wall. A frame member is positioned proximate the support wall. The frame member has support legs which extend therefrom in a direction way from the vertical wall. The frame member and support legs support the cooler when the cooler is rotated and positioned on a surface.

### FIELD OF THE INVENTION

The present invention is directed to a cooler, structure for transporting a cooler and a method for transporting the same. More particularly, the present invention is directed to frames and support members which are provided on the cooler to facilitate the transportation thereof.

### BACKGROUND OF THE INVENTION

Commercial cooling systems can include coolers that are very large. These coolers can be as much as 200 inches in height and can weigh as much as 50,000 pounds. Transportation of these large coolers can be difficult due to the height and weight.

Typically, the coolers are transported on a flat bed truck or the like from the factory to the site. In order to facilitate transportation, the cooler must generally be rotated from a vertical position to a horizontal position prior to, or simultaneous with the cooler being placed on the flatbed. This is done to accommodate the restrictive height requirements associated with the transportation of the cooler.

In order to accommodate the movement or rotation of the cooler, an external frame may be attached to the cooler. This external frame provides additional structure and support to the cooler to allow a hoist or crane to lift and rotate the cooler without damaging the cooler. This adds cost to the cooler.

Additionally, as the horizontal cooler is placed on the flatbed, supports must be provided on the flatbed to allow the cooler to be properly positioned and supported without damaging components of the cooler. This also increases the cost and complexity to the transportation of the cooler.

A cooler, structures for transporting coolers and methods for transporting the same that are easily rotated and supported on the flatbed and that do not suffer from one or more of the above drawbacks would be desirable in the art.

### BRIEF DESCRIPTION OF THE INVENTION

In an exemplary embodiment, a cooler is disclosed. The cooler has a cooling region defined by a support wall, a first wall, a second wall, and a sloped interior section, the sloped interior section extending between the first wall and the second wall and sloping away from the support wall. A discharge region is provided and is defined by the first wall, the second wall, the sloped interior section, and a vertical wall, the vertical wall being substantially parallel to the support wall. A frame member is positioned proximate to the support wall. The frame member has support legs which extend therefrom in a direction away from the vertical wall. The frame member and support legs support the cooler when the cooler is rotated and positioned on a surface.

In another exemplary embodiment a cooler is disclosed. The cooler has a cooling region defined by a support wall, a first wall, a second wall, and a sloped interior section, the sloped interior section extending between the first wall and the second wall and sloping away from the support wall. The cooler also has a discharge region defined by the first wall, the second wall, the sloped interior section, and a vertical wall, the vertical wall being substantially parallel to the support wall. An integral frame member is positioned proximate to the support wall and between the support wall and the vertical wall. The frame member has support legs which extend therefrom in a direction away from the vertical wall. The frame member and support legs support the cooler when the cooler is rotated and positioned on a surface.

In another exemplary embodiment a process of transporting a cooler is disclosed. The cooler has load support legs extending away from a support surface of the cooler. The process comprising: lifting the cooler; rotating the cooler so that the load support legs are in an essentially vertical position; and lowering the cooler onto a transportation surface such that load bearing surfaces of the load support legs engage the transportation surface. The weight of the cooler is distributed over and supported by the load bearing surfaces, the load support legs and the frame.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a front perspective view of an exemplary cooler showing a vertical discharge region, a fan and a support frame according to the disclosure.

FIG. 2 is a front perspective view of the exemplary cooler of FIG. 1 with the fan removed.

FIG. 3 is a back perspective view of the exemplary cooler of FIG. 1.

FIG. 4 is a top view of the exemplary cooler of FIG. 1.

FIG. 5 is a front perspective view of the exemplary cooler of FIG. 1 a fan support wall removed.

FIG. 6 is a side view of the exemplary cooler of FIG. 1 rotated to a vertical position and placed on a horizontal transportation surface.

FIG. 7 is a front perspective view of an alternate exemplary cooler showing a vertical discharge region, a fan receiving area and a support frame according to the disclosure.

Wherever possible, the same reference numbers will be used throughout the drawings to represent the same parts.

### DETAILED DESCRIPTION OF THE INVENTION

Provided is a cooler, a structure for transporting coolers and a method for transporting the same. Embodiments of the disclosure permit simpler, cost effective and/or safer transportation and installation of a cooler.

The present invention will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that spatially relative terms, such as “top”, “upper”, “lower”, “horizontal”, “vertical” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned or rotated, elements described as “horizontal” would then be oriented as “vertical”. Thus, the exemplary term “horizontal” can encompass an orientation of horizontal, vertical or inbetween. The device may be otherwise oriented (rotated 90 degrees or at other orientations) and the spatially relative descriptors used herein interpreted accordingly.

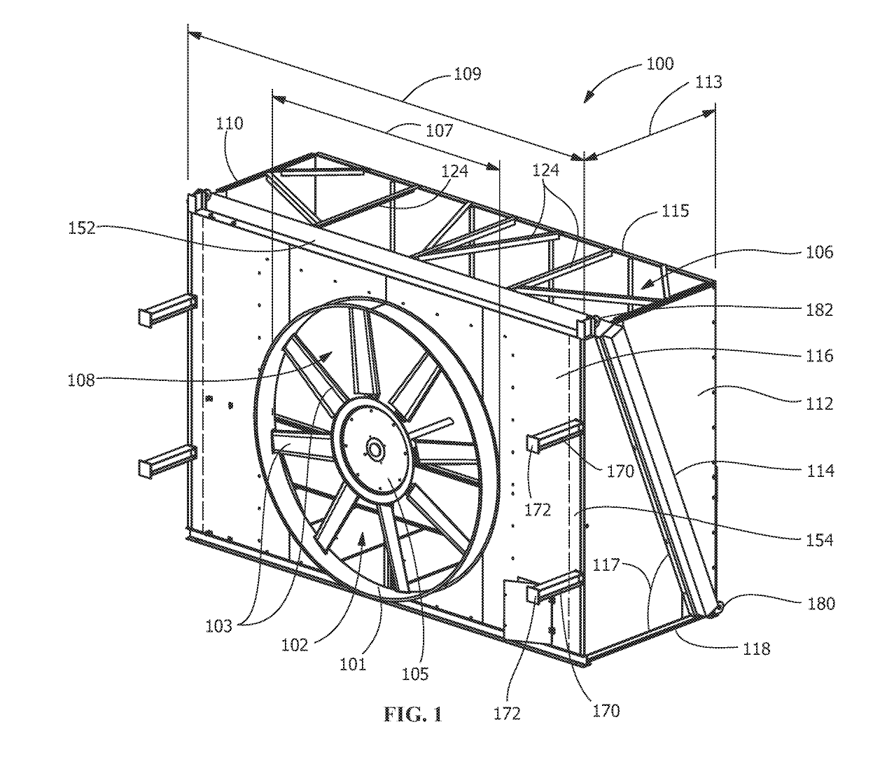

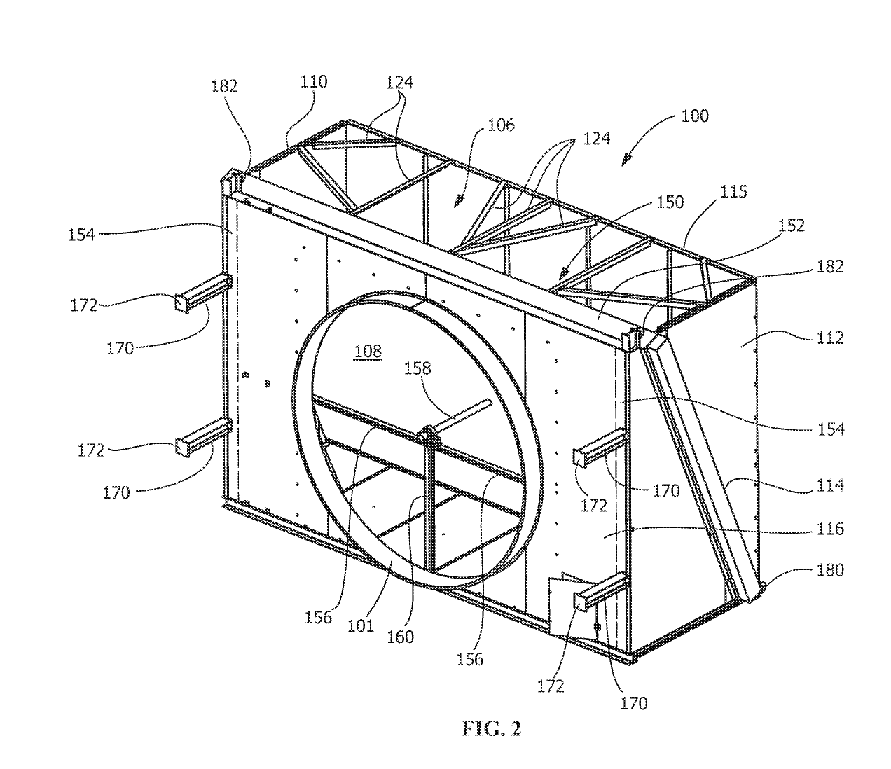

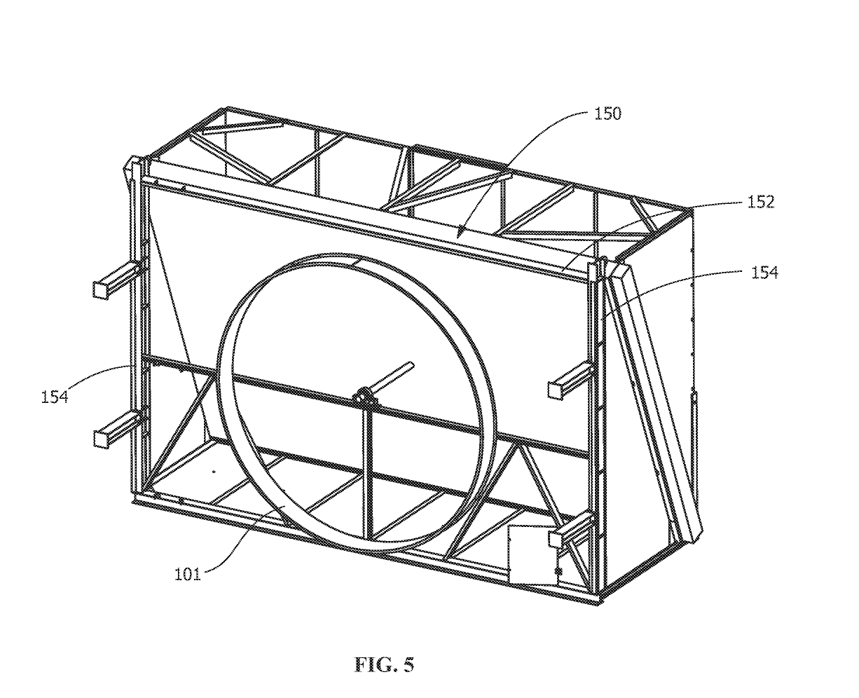

FIGS. 1 through 6 illustrate an exemplary embodiment of a cooler 100, such as a vertical discharge cooler. The cooler 100 is a part of or operable with any suitable cooling system. For example, in one embodiment, the cooling system is operable with an electric motor, is a part of a gas compression system, is engine-driven or electric-motor-driven, or combinations thereof. In one embodiment, the cooler 100 provides compression between about 100 HP and about 2,500 HP or between about 250 HP and about 4,500 HP, for example, as in a multi-stage cooler.

As best shown in FIG. 1, the cooler 100 includes a fan 102, such as a forced-draft fan or an induced-draft fan. In one embodiment, the cooler 100 includes a plurality of the fans 102. The fan 102 includes a plurality of blades 103 extending radially about a hub 105. In one embodiment, the fan 102 includes eight of the blades 103. The fan 102 includes a predetermined diameter 107, for example, about 24 inches, about 32 inches, about 36 inches, about 42 inches, about 48 inches, about 54 inches, about 60 inches, about 72 inches, about 81 inches, about 84 inches, about 93 inches, about 96 inches, about 108 inches, about 120 inches, about 132 inches, about 144 inches, about 156 inches, about 168 inches, or above any one of the predetermined diameters 107.

The fan 102 is positioned within a fan support wall 116, such as a vertical wall with an aperture for the fan 102. The fan support wall 116 extends a predetermined length 109, for example, about 28 inches, about 40 inches, about 52 inches, about 64 inches, about 88 inches, about 100 inches, about 112 inches, about 124 inches, about 136 inches, about 160 inches, about 184 inches, about 208 inches, about 232 inches, about 256 inches, about 280 inches, about 304 inches, about 328 inches or above any of the predetermined lengths 109. The fan support wall 116 extends a predetermined height 111, for example, about 32 inches, about 41 inches, about 46 inches, about 59 inches, about 66 inches, about 80 inches, about 84 inches, about 93 inches, about 103 inches, about 104 inches, about 115 inches, about 122 inches, about 133 inches, about 136 inches, about 147 inches, about 158 inches, about 169 inches, about 172 inches, about 178 inches, about 186 inches, about 197 inches, or above any of the predetermined heights 111.

The fan 102 draws in a gaseous fluid 104, such as air, gas, natural gas, engine exhaust, combustion exhaust, turbine exhaust, any other suitable compression fluid, or combinations thereof, through a fan support structure 101 extending from the fan support wall 116. The fan 102 draws the gaseous fluid 104 into a cooling region 108 defined by the fan support wall 116, a first wall 110, a second wall 112, and a sloped interior section 114. In one embodiment, the first wall 110 and the second wall 112 are parallel to each other, perpendicular to the fan support wall 116, and extend to substantially the predetermined height 111 of the fan support wall 116. The first wall 110 and the second wall 112 each extend from the fan support wall 116 to a vertical wall 115 opposite the fan support wall 116 at a predetermined depth 113, for example, about 33 inches, about 36 inches, about 39 inches, about 44 inches, about 47 inches, about 52 inches, about 54 inches, about 58 inches, about 64 inches, about 69 inches, about 73 inches, about 76 inches, about 80 inches, about 84 inches, about 88 inches, about 90 inches, about 93 inches, about 94 inches, about 96 inches, about 100 inches, about 108 inches, about 113 inches, or above any of the predetermined widths 113.

As shown in FIGS. 1-3 and 5, the sloped interior section 114 extends between the first wall 110 and the second wall 112 sloping away from the fan support wall 116 as it extends toward a lower portion 118 in a direction opposite a discharge region 106 at a predetermined angle 117, for example, about 10 degrees, about 20 degrees, about 30 degrees, about 45 degrees, greater than about 10 degrees, greater than about 20 degrees, greater than about 30 degrees, between about 10 degrees and 45 degrees, between about 20 degrees and about 45 degrees, between about 30 degrees and about 45 degrees, between about 20 degrees and about 30 degrees, or any combination or sub-combination thereof. In one embodiment, the sloped interior section 114 is positioned to create a center of gravity proximal to the center of the cooler 100. The sloped interior section 114 includes one or more sections (not shown), and each one or more section includes one or more piping connections (not shown).

The sloped interior section 114 includes any suitable features for transporting, compressing, heating and/or cooling the gaseous fluid 104. For example, in one embodiment, the sloped interior section 114 includes flow control features (not shown), such as adjustable shutters, fixed turning vanes, and combinations thereof. Additionally or alternatively, in one embodiment, the sloped interior section 114, the lower portion 118 opposite the fan support wall 116, and/or the discharge region 106 include features or components susceptible to damage, for example, by environmental hazards such as hail, rain, ice, airborne debris, particulate, other substances encountered during transportation or operation, or combinations thereof.

The gaseous fluid 104 is heated or cooled then vertically expelled through the discharge region 106 of the cooler 100. The discharge region 106 is defined by the first wall 110, the second wall 112, the sloped interior section 114, and the vertical wall 115. The vertical wall 115 is substantially parallel to the fan support wall 116. The vertical wall 115, the first wall 110, the fan support wall 116, and the second wall 112 extend in a substantially rectilinear arrangement to form a cooling structure 122 having a predetermined footprint.

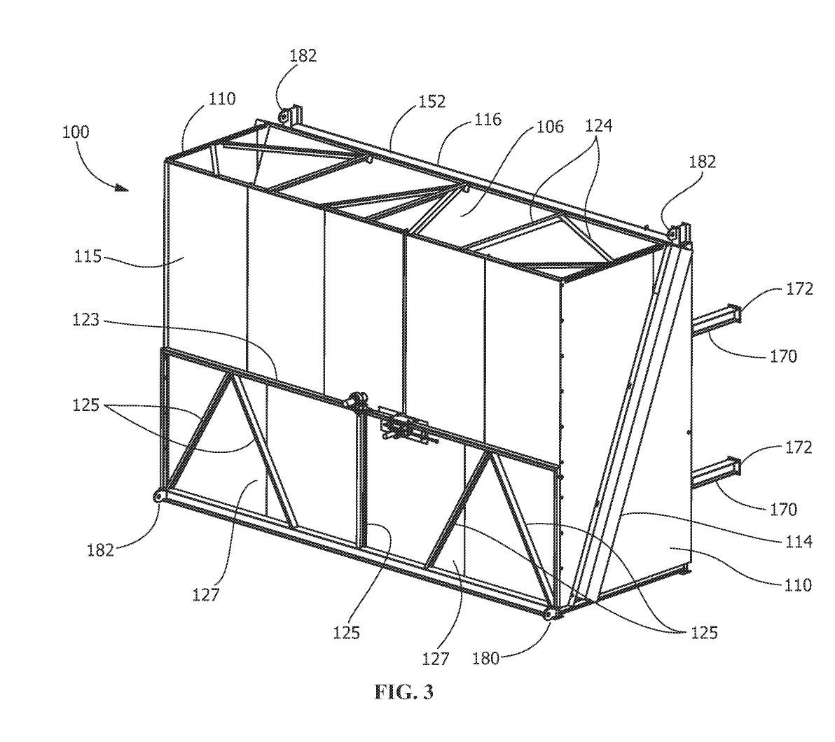

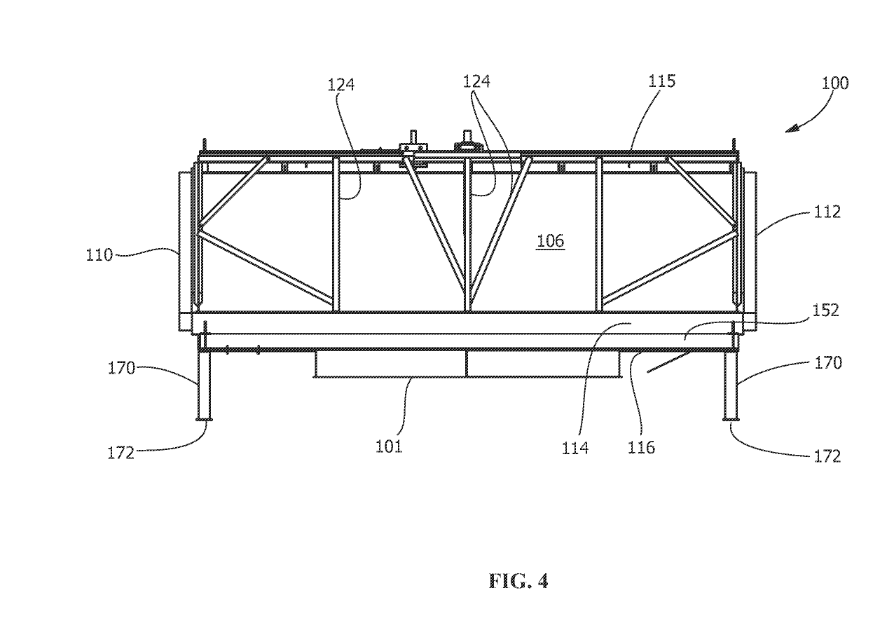

As best shown in FIGS. 3 and 4, the cooler 100 includes structural components for support, such as one or more horizontal members 123, 124, one or more support members 125, or combinations thereof. One or more of the structural components are positioned in the discharge region 106. The structural components extend from the sloped interior section 114, the vertical wall 115, the horizontal member 123, the first wall 110, the second wall 112, or combinations thereof. The horizontal member 123 extends along the length of the vertical wall 115 and is supported by the support members 125.

In one embodiment, the support members 125 are arranged with angled and vertical orientations, thereby providing additional support based upon their combined geometry. For example, in one embodiment, the support members 125 form one or more triangles 127, thereby distributing weight of the horizontal member 123. In a further embodiment, one or more of the support members 125 extend from the one or more triangles 127, providing further structural support. In another embodiment, the support members 125 are arranged with wider portions 129 abutting the vertical wall 115 on some of the support members 125 and narrower portions 131 abutting the vertical wall 115 on others of the support members 125.

As shown in FIGS. 1, 2 and 5, integral frame member 150 is positioned proximate to the fan support wall 116. The frame member 150 is positioned between the fan support wall 116 and the vertical wall 115. The frame member 150 has a horizontal member 152 and at least two vertical members 154. In the exemplary embodiment shown, the vertical members 154 extend from proximate to ends of the horizontal member 152. The horizontal member 152 of the frame member 150 is provided between the fan support wall 116 and the upper surface of the sloped interior section 114, such that the upper surface of the sloped interior section 114 engages the horizontal member 152. In the exemplary embodiment shown, the fan support wall 116 is attached to the horizontal member 152 and the vertical members 154, the first wall 110 and the second wall 112 are attached to the vertical members 154, and the sloped interior section 114 is attached to the horizontal member 152. The integral frame member 150 thereby adds additional support and structure to the cooler 100.

One or more fan support members 156 are attached to the vertical members 154. The fan support member 156 cooperates with a fan shaft 158 to maintain the fan 102 attached to the fan shaft 158 in position. Additional fan supports 160 may be positioned along the length of the fan support member 158 to provide additional support thereto.

Load support legs 170 extend from the fan support wall 116 in a direction away from the vertical wall 115. The load support legs 170 extend in a direction which is essentially perpendicular to the surface of the fan support wall 116. The load support legs 170 are attached to the frame member 150 by means of bolts, welds or other known methods. In the exemplary embodiment shown, four load support legs 170 are attached to the vertical members 154, but other number of legs and other configurations are possible without departing from the invention. The frame member 150 and legs 170 are made from steel or other material having the strength characteristics required. Flat load bearing surfaces or feet 172 are provided at the ends of the legs 170 which are not attached to the frame member 150. The legs 170 have sufficient length to extend beyond the fan support structure 101 or any other portion of the cooler 100 which extends from the fan support wall 116.

Lifting projections 180, 182 are provided on the cooler. Lifting projections 180 are positioned on and extend from the vertical wall 115, the first wall 110, the second wall 112, the intersection of any of the walls 115, 110, 112, or any combination thereof. In the exemplary embodiment shown, two lifting projections 180 are provided proximate to the bottom of the cooler 100, one proximate to the first wall 110 and one proximate to the second wall 112. Lifting projections 182 are positioned on and extend from the horizontal member 152, the vertical member 154, the intersection of the vertical member 154 and the horizontal member 152, or any combination thereof. In the exemplary embodiment shown, two lifting projections 182 are provided proximate to the top of the cooler 100, one proximate to the first wall 110 and one proximate to the second wall 112. The lifting projections 180, 182 having an opening or projection which receives a portion of a lifting mechanism, such as, but not limited to, a hoist or crane, thereby allowing the lifting mechanism to lift and rotate the cooler, as will be more fully described.

When the cooler is to be moved or transported, the cooler 100 must be lifted by machinery such as, but not limited to, a crane or hoist. The lifting mechanism is attached to the lifting projections 180, 182 and lifted. As the lifting projections 180 are positioned proximate to the bottom of the cooler 100 and the lifting projections 182 are positioned proximate the top of the cooler 100, the operation of the machinery allows the top and bottom of the cooler 100 to be lifted and manipulated differently, allowing the cooler 100 to be rotated.

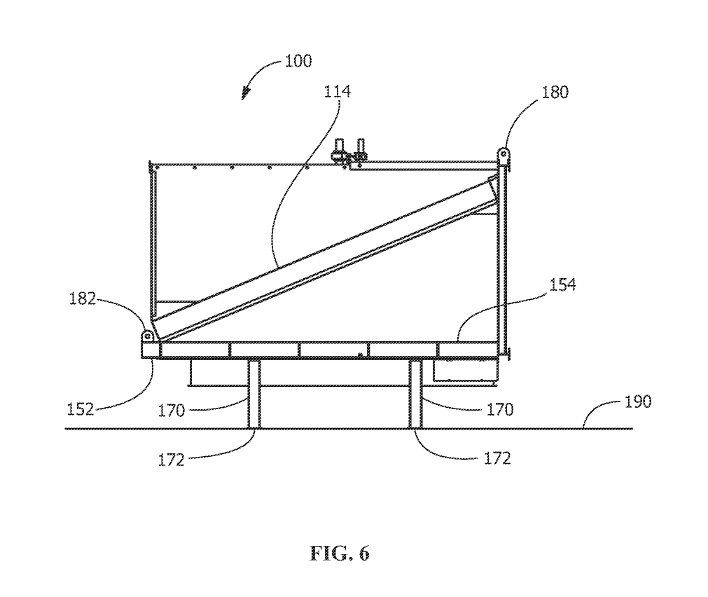

As the cooler 100 is rotated, the load support legs 170 are moved to extend downward in an essentially vertical position, as shown in FIG. 6. With the legs 170 properly positioned, the cooler may be lowered or loaded onto a flatbed truck or other transportation surface or medium 190. The load bearing surfaces 172 cooperate and engage the transportation surface, providing a sufficient surface to allow the cooler 100 to be positioned on the flatbed in a stable position. This allows the cooler 100 to have a lower profile when transported, thereby allowing the cooler 100 to be transported along roadways and rail lines in which the height of loads must be governed. As the legs 170 extend from the fan support wall 116 further than any other portion of the cooler 100, the positioning of the cooler 100 on the legs 170 does not damage any portion of the cooler 100. The use of the integral frame 150 and the support legs 170 allows the cooler 100 to be easily transported and moved into position. The weight of the cooler 100 is distributed over and supported by the load bearing surface 172, the load support legs 170 and the frame 150. Once the cooler 100 is properly delivered, the cooler 100 is removed from the flatbed or other transportation medium, and the cooler 100 is again lifted and placed in position. The legs 170 may then be removed if desired.

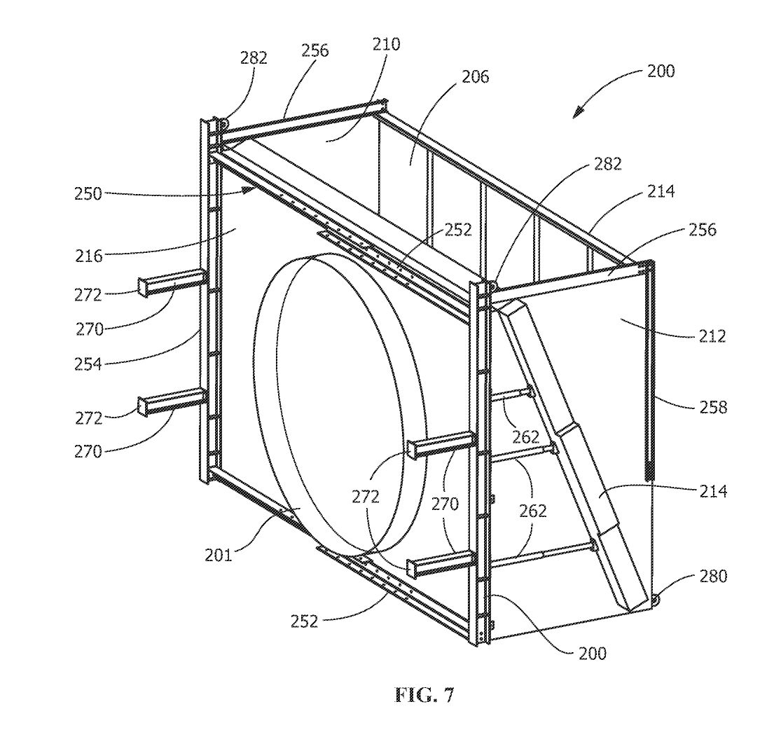

Referring to FIG. 7, an alternate exemplary embodiment is shown in which a frame member 250 extends over portions of the fan support wall 216, the first wall 210, the second wall 212, and the vertical wall 215. The frame member 250 has horizontal members 252 and two vertical members 254 which are positioned proximate to the fan support wall 216. The horizontal member 252 may be adjustable to allow the frame member 250 to be used with coolers 200 of different sizes. In the exemplary embodiment shown, the vertical members 254 extend from proximate to the ends of the horizontal member 252. In the exemplary embodiment shown, the horizontal member 252 and the vertical members 254 are attached to the fan support wall 216 by means of bolts or other known fasteners.

The frame member 250 also has horizontal members 256 which are positioned proximate to the first wall 210 and the second wall 212. The horizontal members 256 may be adjustable to allow the frame member 250 to be used with coolers 200 of different sizes. In the exemplary embodiment shown, the horizontal members 256 extend from the vertical members 254. Additional vertical members 258 are provided on the frame member 250 proximate to the vertical wall 215. In the exemplary embodiment shown, the vertical members 258 extend from proximate to the ends of the horizontal members 256. In the exemplary embodiment shown, the vertical members 258 are attached to the vertical wall 215 by means of bolts or other known fasteners. The frame member 250 adds additional support and structure to the cooler 200.

Support jacks 262 extend from vertical members 254. The support jacks 262 extend in a direction which is essentially perpendicular to the surface of the fan support wall 216. The support jacks 262 are positioned periodically along the vertical members 254 are configured to cooperate with the sloped interior section 214. This provides greater stability to the cooler 200 as the cooler 200 is lifted and rotated. In the exemplary embodiment shown, three jacks 262 are provided on each vertical member 254, but other configurations can be used. The jacks 262 have angled feet 264 which are dimensioned to cooperate with the sloped interior section 214.

Load support legs 270 extend from the vertical members 254 in an opposed direction as the support jacks 262 and in a direction away from the vertical wall 215. The load support legs 270 extend in a direction which is essentially perpendicular to the surface of the fan support wall 216. The load support legs 270 are attached to the frame member 250 by means of bolts, welds or other known methods. In the exemplary embodiment shown, four load support legs 270 are attached to the vertical members 254, but other number of legs and other configurations are possible without departing from the invention. The frame member 250 and legs 270 are made from steel or other material having the strength characteristics required. Flat load bearing surfaces or feet 272 are provided at the ends of the legs 270 which are not attached to the frame member 250. The legs 270 have sufficient length to extend beyond the fan support structure 201 or any other portion of the cooler 200 which extends from the fan support wall 216.

Lifting projections 280, 282 are provided on the cooler. Lifting projections 280 are positioned on and extend from the vertical wall 215, the first wall 210, the second wall 212, the intersection of any of the walls 215, 210, 212, or any combination thereof. In the exemplary embodiment shown, two lifting projections 280 are provided proximate to the bottom of the cooler 200, one proximate to the first wall 210 and one proximate to the second wall 212. Lifting projections 282 are positioned on and extend from the horizontal member 252, the vertical member 254, the intersection of the vertical member 254 and the horizontal member 252, or any combination thereof. In the exemplary embodiment shown, two lifting projections 282 are provided proximate to the top of the cooler 200, one proximate to the first wall 210 and one proximate to the second wall 212. The lifting projections 280, 282 having an opening or projection which receives a portion of a lifting mechanism, such as, but not limited to, a crane or hoist, thereby allowing the lifting mechanism to lift and rotate the cooler, as will be more fully described.

When the cooler is to be moved or transported, the cooler 200 must be lifted by machinery such as, but not limited to, a crane or hoist. The lifting mechanism is attached to the lifting projections 280, 282 and lifted. As the lifting projections 280 are positioned proximate to the bottom of the cooler 200 and the lifting projections 282 are positioned proximate to the top of the cooler 200, the operation of the machinery allows the top and bottom of the cooler 200 to be lifted and manipulated differently, allowing the cooler 200 to be rotated.

As the cooler 200 is rotated, the load support legs 270 are moved to extend downward in an essentially vertical position. As this occurs, the support jacks 262 cooperate with the sloped interior section 214 to provide support to the sloped interior section 214. With the legs 270 properly positioned, the cooler may be lowered or loaded onto a flatbed truck or other transportation surface or medium. The load bearing surfaces 272 cooperate and engage the transportation surface, providing a sufficient surface to allow the cooler 200 to be positioned on the flatbed in a stable position. This allows the cooler 200 to have a lower profile when transported, thereby allowing the cooler 200 to be transported along roadways and rail lines in which the height of loads must be governed. As the legs 270 extend from the fan support wall 216 further than any other portion of the cooler 200, the positioning of the cooler 200 on the legs 270 does not damage any portion of the cooler 200. The use of the integral frame 250 and the support legs 270 allows the cooler 200 to be easily transported and moved into position. The weight of the cooler 200 is distributed over and supported by the load bearing surface 272, the load support legs 270, the support jacks 262 and the frame 250. Once the cooler 100 is properly delivered, the cooler 200 is removed from the flatbed or other transportation medium, and the cooler 100 is again lifted and placed in position. The legs 270 may then be removed if desired.

As the cooler 200 is rotated, the load support legs 270 are moved to extend downward. As this occurs, the support jacks 262 cooperate with the sloped interior section 214 to provide support to the sloped interior section 214. With the legs 270 properly positioned, the cooler may be loaded onto a flatbed truck or other transportation medium. The load bearing surfaces 272 cooperate and engage the flatbed, providing a sufficient surface to allow the cooler 200 to be positioned on the flatbed in a stable position. This allows the profile of the cooler 200 to be lower when transported, thereby allowing the cooler 200 to be transported along roadways and rail lines in which the height of loads must be governed. As the legs 270 extend from the fan support wall 216 further than any other portion of the cooler 200, the positioning of the cooler 200 on the legs 270 does not damage any portion of the cooler 200. The use of the integral frame 250 and the support legs 270 allows the cooler 200 to be easily transported and moved into position. Once the cooler 200 is removed from the flatbed or other transportation medium, the cooler 200 is again lifted and placed in position. The frame 250 may then be removed and reused if desired.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A cooler, comprising:
a cooling region defined by a support wall, a first wall, a second wall, and a sloped interior section, the sloped interior section extending between the first wall and the second wall and sloping away from the support wall;
a discharge region defined by the first wall, the second wall, the sloped interior section, and a vertical wall, the vertical wall being substantially parallel to the support wall; and
a frame member positioned proximate the support wall, the frame member having support legs which extend therefrom in a direction way from the vertical wall,
whereby, the frame member and support legs support the cooler when the cooler is rotated and positioned on a surface.

2. The cooler of claim 1, wherein the frame member has a horizontal member and at least two vertical members.

3. The cooler of claim 2, wherein the support legs are attached to the at least two vertical members.

4. The cooler of claim 1, wherein the frame member extends over portions of the support wall.

5. The cooler of claim 4, wherein portions of the frame member are adjustable to allow the frame member to be used with coolers of different sizes.

6. The cooler of claim 4, further comprising support jacks extending from the frame member, the support jacks extending from the frame member to the sloped interior section to provide additional support.

7. The cooler of claim 1, wherein the support legs extend in a direction which is essentially perpendicular to a surface of the support wall.

8. The cooler of claim 7, wherein the support legs have load bearing surface provided at the ends thereof.

9. The cooler of claim 1, further comprising lifting projections extending from the frame member proximate the top of the cooler, the lifting projections cooperate with a lifting mechanism to allow the lifting mechanism to lift and rotate the cooler.

10. The cooler of claim 1, further comprising a fan positioned proximal the support wall, the support wall being a fan support wall.

11. The cooler of claim 1, wherein the cooler is a vertical discharge cooler.

12. The cooler of claim 1, wherein the sloped interior section slopes away from the support wall at a predetermined angle, the predetermined angle being greater than about 10 degrees.

13. The cooler of claim 1, wherein the sloped interior section is positioned to create a center of gravity proximal to the center of the cooler.

14. The cooler of claim 1, wherein the sloped interior section includes flow control features.

15. The cooler of claim 1, wherein the cooler has a substantially rectilinear arrangement having a predetermined footprint.

16. A cooler, comprising:
a cooling region defined by a support wall, a first wall, a second wall, and a sloped interior section, the sloped interior section extending between the first wall and the second wall and sloping away from the support wall;
a discharge region defined by the first wall, the second wall, the sloped interior section, and a vertical wall, the vertical wall being substantially parallel to the support wall; and
an integral frame member positioned proximate the support wall and between the support wall and the vertical wall, the frame member having support legs which extend therefrom in a direction way from the vertical wall,
whereby, the frame member and support legs support the cooler when the cooler is rotated and positioned on a surface.

17. The cooler of claim 16, wherein the support legs have load bearing surface provided at the ends thereof.

18. The cooler of claim 16, further comprising lifting projections extending from the frame member proximate the top of the cooler, the lifting projections cooperate with a lifting mechanism to allow the lifting mechanism to lift and rotate the cooler.

19. The cooler of claim 16, wherein the frame member has a horizontal member and at least two vertical members, the support legs attached to the at least two vertical members.

20. A process of transporting a cooler with load support legs extending away from a support surface of the cooler, the process comprising:
lifting the cooler;
rotating the cooler so that the load support legs are in an essentially vertical position;
lowering the cooler onto a transportation surface such that load bearing surfaces of the load support legs engage the transportation surface;
whereby the weight of the cooler is distributed over and supported by the load bearing surfaces, the load support legs and the frame.
